(19) United States
(12) Patent Application Publication
(10) Pub. No.: US 2026/0120050 A1
(43) Pub. Date: Apr. 30, 2026

(54) COLLABORATIVE TOOL FOR INVENTORY MANAGEMENT

(71) Applicant: Schlumberger Technology Corporation, Sugar Land, TX (US)

(72) Inventors: Haw Keat Lim, Singapore (SG); Abdulrahman Mustafa Abdulqader, Houston, TX (US)

(21) Appl. No.: 18/931,959

(22) Filed: Oct. 30, 2024

(51) Int. Cl. G06Q 10/087; G06Q 50/06

(52) U.S. Cl. CPC G06Q 10/087; G06Q 50/06

(57) ABSTRACT

The present disclosure relates to systems and methods for inventory management in the oil and gas industry. The systems and methods automate the inventory tracking process and provide a real time status of inventory. The systems and methods analyze the data of the inventory to generate insights of the inventory and provide recommended actions for the inventory. The systems and methods provide an interactive user interface that allows users to provide requests relating to inventory and display insights of the inventory.

### BACKGROUND OF THE DISCLOSURE

Wellbores are commonly drilled from a surface location or seabed for various exploration and extraction activities. These wellbores are used to access and extract fluid resources like liquid and gaseous hydrocarbons from subterranean formations. The construction of wellbores involves the use of earth-boring equipment such as drill bits for initial drilling and reamers for enlarging the wellbore diameters.

Typically inventory management for a drilling location is performed using spreadsheets used to generate reports of the inventory. The reports can include details such as inventory status or condition, total inventory value, total inventory moving and/or assigned and inventory not moving. These reports can also include total value, and individual component comments. The reports are typically manually maintained, updated regularly, and shared periodically among users.

### SUMMARY

This summary is provided to introduce a selection of concepts that are further described in the detailed description. This summary is not intended to identify key or essential features of the claimed subject matter, nor is it intended to be used as an aid in limiting the scope of the claimed subject matter.

Some implementations relate to a method. The method includes accessing data for connected assets in an oil and gas inventory system. The method includes analyzing, using a machine learning model, the data using an algorithm. The method includes generating a real time status of the connected assets in response to analyzing the data. The method includes displaying, on a user interface, an inventory list of the connected assets with the real time status of the connected assets.

Some implementations relate to a system. The system includes a memory to store data and instructions; and a processor operable to communicate with the memory, wherein the processor is operable to: access data for connected assets in an oil and gas inventory system; analyze, using a machine learning model, the data using an algorithm; generate a real time status of the connected assets in response to analyzing the data; and display, on a user interface, an inventory list of the connected assets with the real time status of the connected assets.

Some implementations relate to a computer-readable storage medium including instructions that, when executed by a processor, cause the processor to: access data for connected assets in an oil and gas inventory system; analyze, using a machine learning model, the data using an algorithm; generate a real time status of the connected assets in response to analyzing the data; and display, on a user interface, an inventory list of the connected assets with the real time status of the connected assets.

Additional features and aspects of implementations of the disclosure will be set forth herein, and in part will be obvious from the description, or may be learned by the practice of such implementations. The features and advantages of such implementations may be realized and obtained by means of the instruments and combinations particularly pointed out in the appended claims. These and other features will become more fully apparent from the following description and appended claims, or may be learned by the practice of such implementations as set forth hereinafter.

### BRIEF DESCRIPTION OF THE DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 is an example of a downhole system in accordance with implementations of the present disclosure.

FIG. 2 illustrates an example environment for inventory management in accordance with implementations of the present disclosure.

FIG. 3 illustrates an example graphical user interface of a real time inventory status in accordance with implementations of the present disclosure.

FIG. 4 illustrates an example method for inventory management in accordance with implementations of the present disclosure.

FIG. 5 illustrates components that may be included within a computer system.

### DETAILED DESCRIPTION

This disclosure generally relates to systems and methods for inventory management in the oil and gas industry. Typically inventory management in the oil and gas industry is performed using spreadsheets used to generate reports of the inventory. The reports can include details such as inventory status or condition, total inventory value, total inventory moving and/or assigned, and inventory not moving. The reports can also include total value and individual component comments. The reports can include details such as inventory status or condition, total inventory value, total inventory moving and/or assigned and inventory not moving. The reports are typically manually maintained by users adding comments to the reports with the information and shared periodically among users. The users may be in different locations worldwide as drilling operations may occur globally. Users manually updating the reports is prone to human error and can have consequences on delays in inventory arriving at drilling locations or delays in understanding an item in inventory may be damage or in need of repair.

The systems and methods of the present disclosure provide an inventory management tool for the oil and gas industry to communicate inventory status to users. The inventory management tool automates the inventory tracking process and provides a property status to a user of the inventory management tool in real time. The inventory management tool provides an interactive user interface that allows users to provide queries relating to inventory, display insights of the inventory, and request actions relating to the inventory. The inventory management tool is a collaborative tool users can use to manage inventory.

As will be discussed in further detail below, the present disclosure includes a number of practical applications having features described herein that provide benefits and/or solve problems associated with inventory management. Some example benefits are discussed herein in connection with various features and functionalities provided by the inventory management tool implemented on one or more computing devices. It will be appreciated that benefits explicitly discussed in connection with one or more implementations described herein are provided by way of example and are not intended to be an exhaustive list of all possible benefits of the inventory management tool.

For example, one benefit includes consolidating into a single platform tracking of the inventory from the manufacturing process to delivery, through installation and use, until the inventory is no longer in use. The systems and methods track an entire history of an item with details capturing the history of the item and any changes or repairs made to the item. Another example benefit includes automated workflows for inventory management. In some implementations, the systems and methods automatically perform actions in response to the inventory levels exceeding a threshold or the inventory levels dropping below a threshold. Another example benefit includes sustainability. The systems and methods provide full visibility of all operations worldwide and enables better understanding of inventory needs and available inventory to meet the inventory needs. Reliably automating the inventory management process yields an improvement in oil and gas industry.

In some implementations, the inventory management tool is a cloud application based tool. The inventory management tool includes a user facing user interface that shows real time inventory status to the users, along with making reports available to the users (e.g., clients, account managers, etc.). The inventory management tool automates activities related to inventory management. In some implementations, the inventory management tool uses algorithms and machine learning models to automatically trigger actions for the inventory. One example action is automatically ordering items. Another example action is automatically scheduling inspections or repairs of items. In some implementations, the inventory management tool automatically informs teams if the required inventory is available for the repair, removing the overall number of steps required to plan a repair.

In some implementations, the systems and method use application programming interfaces (API)s to allow the inventory management tool to pull the latest data from different data sources for the inventory and push any new updates to the inventory management tool. In some implementations, the systems and methods use connectors (backend services interfacing with the APIs) for pulling or pushing data between the data sources and the inventory management tool. In some implementations, the systems and methods use data storage for the inventory management tool to store any data (e.g., appended comments and inventory status) for the inventory. In some implementations, the systems and methods use backend services to manage the components and data flow of the inventory management tool. In some implementations, the systems and methods use a frontend service (the user interface) that the user interacts with for accessing the inventory management tool and viewing the information generated by the inventory management tool.

One of the technical advantages of the systems and methods of the present disclosure is automating the inventory management process. Another technical advantage of the systems and methods of the present disclosure is providing a real time inventory status. The systems and methods of the present disclosure provide real time visibility and reporting of inventory to users. The systems and methods of the present disclosure improve sustainability by understanding the available inventory and moving available inventory to respond to requests of users helping the users receive the inventory on time without initiating manufacturing of the items if the items are already available in the inventory.

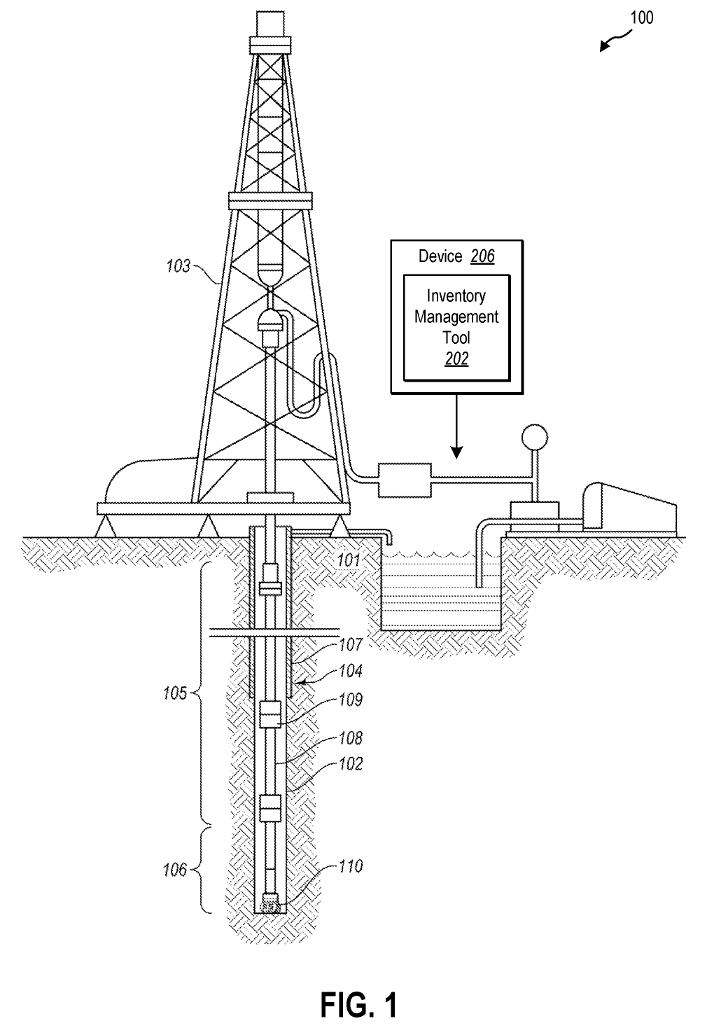

Additional details will now be provided regarding systems described herein in relation to illustrative figures portraying example implementations. For example, FIG. 1 shows one example of a downhole system 100 for drilling an earth formation 101 to form a wellbore 102. The downhole system 100 includes a drill rig 103 used to turn a drilling tool assembly 104 which extends downward into the wellbore 102. The drilling tool assembly 104 may include a drill string 105, a bottomhole assembly (“BHA”) 106, and a bit 110, attached to the downhole end of the drill string 105.

The drill string 105 may include several joints of drill pipe 108 connected end-to-end through tool joints 109. The drill string 105 transmits drilling fluid through a central bore and transmits rotational power from the drill rig 103 to the BHA 106. In some implementations, the drill string 105 further includes additional downhole drilling tools and/or components such as subs, pup joints, etc. The drill pipe 108 provides a hydraulic passage through which drilling fluid is pumped from the surface. The drilling fluid discharges through selected-size nozzles, jets, or other orifices in the bit 110 for the purposes of cooling the bit 110 and cutting structures thereon, and for lifting cuttings out of the wellbore 102 as it is being drilled.

The BHA 106 may include the bit 110, other downhole drilling tools, or other components. An example BHA 106 may include additional or other downhole drilling tools or components (e.g., coupled between the drill string 105 and the bit 110). Examples of additional BHA components include drill collars, stabilizers, measurement-while-drilling (“MWD”) tools, logging-while-drilling (“LWD”) tools, downhole motors, underreamers, section mills, hydraulic disconnects, jars, vibration or dampening tools, other components, or combinations of the foregoing.

In general, the downhole system 100 may include other downhole drilling tools, components, and accessories such as special valves (e.g., kelly cocks, blowout preventers, and safety valves). Additional components included in the downhole system 100 may be considered a part of the drilling tool assembly 104, the drill string 105, or a part of the BHA 106, depending on their locations in the downhole system 100.

The bit 110 in the BHA 106 may be any type of bit suitable for degrading downhole materials. For instance, the bit 110 may be a drill bit suitable for drilling the earth formation 101. Example types of drill bits used for drilling earth formations are fixed-cutter or drag bits. In other implementations, the bit 110 may be a mill used for removing metal, composite, elastomer, other materials downhole, or combinations thereof. For instance, the bit 110 may be used with a whipstock to mill into casing 107 lining the wellbore 102. The bit 110 may also be a junk mill used to mill away tools, plugs, cement, other materials within the wellbore 102, or combinations thereof. Swarf or other cuttings formed by use of a mill may be lifted to the surface 111 or may be allowed to fall downhole. The bit 110 may include one or more cutting elements for degrading the earth formation 101.

The BHA 106 may further include a rotary steerable system (RSS). The RSS may include directional drilling tools that change a direction of the bit 110, and thereby the trajectory of the wellbore. At least a portion of the RSS may maintain a geostationary position relative to an absolute reference frame, such as one or more of gravity, magnetic north, or true north. Using measurements obtained with the geostationary position, the RSS may locate the bit 110, change the course of the bit 110, and direct the directional drilling tools on a projected trajectory. The RSS may steer the bit 110 in accordance with or based on a trajectory for the bit 110. For example, a trajectory may be determined for directing the bit 110 toward one or more subterranean targets such as an oil or gas reservoir.

The downhole system 100 may include or may be associated with an inventory management tool 202 accessible via device 206. In some implementations, the inventory management tool 202 is on a remote server in communication with the downhole system 100 via a network. The inventory management tool 202 facilitates users with managing inventory for the downhole system 100.

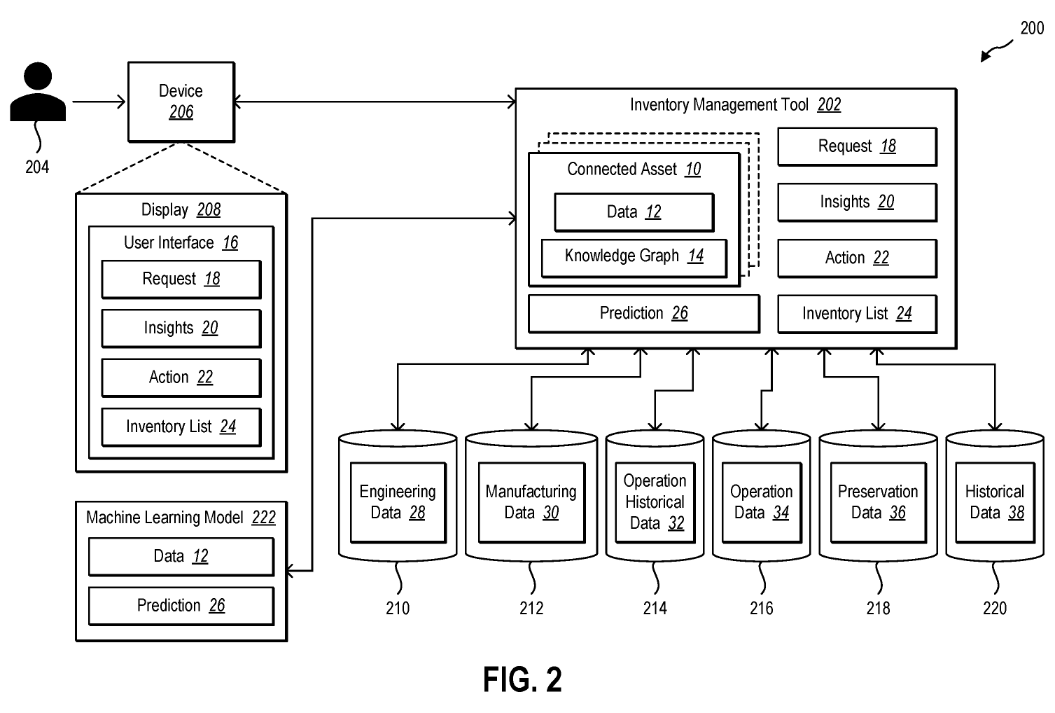

FIG. 2 illustrates an example environment 200 for inventory management in the oil and gas industry. Inventory is a list of items available. Inventory includes assets. Assets are items that have finical value. In some implementations, the inventory includes parts needed to repair the assets. The environment 200 includes an inventory management tool 202 that aids users 204 in managing inventory in the oil and gas industry. For example, a user 204 uses the inventory management tool 202 to manage the inventory needed for a drilling operation (e.g., the downhole system 100 (FIG. 1)).

A user 204 accesses the inventory management tool 202 using a device 206. The device 206 may be representative of one or multiple devices and may refer to various types of computing devices. For example, the device 206 may include a mobile device such as a mobile telephone, a smartphone, a personal digital assistant (PDA), a tablet, a laptop, or any other portable device. Additionally, or alternatively, the device 206 may include one or more non-mobile devices such as a desktop computer, server device, surface or downhole processor or computer (e.g., associated with a sensor, system, or function of the downhole system), or other non-portable device.

In one or more implementations, a user interface 16 is displayed on a display 208. The device 206 may be communicatively coupled (e.g., wired or wirelessly) to the display 208 having the user interface 16 thereon for providing a display of system content.

In some implementations, the inventory management tool 202 is on a cloud server remote from the device 206 of the user 204 accessed through a network. The network may include one or multiple networks and may use one or more communication platforms and/or technologies suitable for transmitting data. The network may refer to any data link that enables transport of electronic data between devices of the environment 200. The network may refer to a hardwired network, a wireless network, or a combination of a hardwired network and a wireless network. In one or more implementations, the network includes the internet. The network may be configured to facilitate communication between the various computing devices via well-site information transfer standard markup language (WITSML) or similar protocol, or any other protocol or form of communication. The server may include one or more computing devices (e.g., including processing units, data storage, etc.) organized in an architecture with various network interfaces for connecting to and providing data management and distribution across one or more client systems.

For example, a uniform resource locator (URL) configured to an end point of the inventory management tool 202 is provided to the device 206 that the user 204 may access using a browser on the device 206. Another example includes an application on the device 206 of the user 204 providing access to the inventory management tool 202. In some implementations, the inventory management tool 202 is a cloud-hosted application that provides access to the inventory management tool 202 to multiple users 204.

The inventory management tool 202 creates a connected asset 10 for each item of the inventory. In some implementations, the connected asset 10 is for an asset in the inventory. In some implementations, the connected asset 10 is for parts used to repair an asset. A connected asset 10 has an identification that the inventory management tool 202 uses to track the connected asset 10. Example identifications include a part number or a serial number. The inventory management tool 202 tracks the history of the connected asset 10 from the initial manufacturing of the connected asset 10, or original purchase of the connected asset 10, to any storage of the connected asset 10 that occurs, delivery of the connected asset 10 to a location, and use of the connected asset 10 until the connected asset 10 is no longer in use. The connected asset 10 includes information about the item of inventory and captures details of the connected asset 10 that the inventory management tool 202 uses to track the connected asset 10 and provide a real time status of the connected asset 10.

The inventory management tool 202 receives data 12 for the connected asset 10 from different data sources 210, 212, 214, 216, 218, 220. In some implementations, the data sources 210, 212, 214, 216, 218, 220 are oil and gas data sources providing information specific to the oil and gas industry. In some implementations, the inventory management tool 202 is on a server in communication with the different data sources 210, 212, 214, 216, 218, 220 through a network. In some implementations, the inventory management tool 202 is on a cloud server remote from the different data sources 210, 212, 214, 216, 218, 220 accessed through the network. For example, the inventory management tool 202 is hosted on virtual machines in the cloud.

In some implementations, the inventory management tool 202 stores the data 12 for the connected asset 10 in a knowledge graph 14. In some implementations, the inventory management tool 202 stores the data 12 for the connected asset 10 in a network. In some implementations, the inventory management tool 202 stores the data 12 for the connected asset 10 in a relational database.

In some implementations, the data 12 is multimodal data and is captured from different types of data provided by the data sources 210, 212, 214, 216, 218, 220. One example type of data is text. Another example type of data is video. Another example type of data is images. Another example type of data is audio. Another example type of data is tables. Another example type of data is graphs. In some implementations, the knowledge graph 14 combines unstructured data of various types from a plurality of data sources 210, 212, 214, 216, 218, 220 into a single location for use by the inventory management tool 202. In some implementations, the knowledge graph 14 combines structured data of various types from the plurality of data sources 210, 212, 214, 216, 218, 220 into a single location for use by the inventory management tool 202. While six data sources are illustrated, it should be appreciated that any number of data sources may be used.

One example includes the data source 210 is an engineering database providing engineering data 28. Examples of engineering data 28 include engineering asset hierarchy information, engineering calculations, engineering validations, and models (e.g., 2D or 3D models). Another example includes the data source 212 is a historical manufacturing database by type of equipment and provides manufacturing data 30 based on an equipment type. Examples of manufacturing data 30 include manufactured time and condition information, installed time and condition information, and any events that may have occurred during installation.

Another example includes the data source 214 is an operation historical database that provides operation historical data 32 collected in the field by type of equipment. Examples of operation historical data 32 include manual inspection reports and operating conditions (e.g., pressure, temperature, estimated flow rates, LoW and CSP) of drilling locations. Another example includes the data source 216 is an operation database with operation data 34 collected from the field. In some implementations, the operation data 34 is obtained from sensors at the downhole system 100 (FIG. 1). Examples of operation data 34 include vibration data (monitoring mechanical vibrations to detect wear in valves and moving parts), acoustic emission sensors (for early detecting of cracks, leaks, and mechanical faults), corrosion rate sensors (real time monitoring of material degradation), flow rate meters (providing accurate measurements for more precise wear predictions), and valve position and cycle counters (tracking valve movements for wear and tear estimations).

Another example includes the data source 218 is a preservation database with perseveration data 36. Examples of perseveration data 36 include environmental data (temperature, humidity), storage conditions (exposure of moisture, contaminants, or corrosive substances), last preservation date (date of last coating, cleaning, or inspection), storage time, and material composition (for corrosion rate predictions). Another example includes the data source 220 is a historical database with historical data 38 based on type of equipment. Examples of historical data 38 include historical failure data (previous failures or wear patterns (LoW, CSP, Quest)) for the type of equipment. The historical data 38 may include information from different locations worldwide for the equipment type.

In some implementations, each data source 210, 212, 214, 216, 218, 220 may provide data (e.g., the engineering data 28, the manufacturing data 30, the operation historical data 32, the operation data 34, the preservation data 36, the historical data 38) in a different format and the knowledge graph 14 combines the data received from each data source into a single location for use by the inventory management tool 202. The data 12 provides any information relating to the connected asset 10 that has been obtained by the different data sources 210, 212, 214, 216, 218, 220. In some implementations, the data 12 provides an entire history of the connected asset 10. For example, the data 12 captures the details of the connected asset 10 in a block chain where each event that occurs to the connected asset 10 is added as a new entry to the block chain. In some implementations, the knowledge graph 14 provides a contextualization of the data 12 aiding in generation of insights for the connected asset 10.

In some implementations, the inventory management tool 202 uses the data 12 to track the connected asset 10. For example, the data 12 provides information on a location of the connected asset 10 (e.g., currently being manufactured, in storage, in transit to a location, or installed and in use at a location). Another example includes the data 12 provides information about a condition of the connected asset 10 (e.g., damaged in transit, original condition, repairs that occurred, or previously used).

In some implementations, the inventory management tool 202 uses the data 12 to provide an inventory list 24 of available connected assets 10 in the inventory. For example, the inventory list 24 includes an identification (e.g., part number or serial number) for the connected asset 10, a description of the connected asset 10, a total number of connected assets 10 available, a location of the connected asset 10, and a status of the connected asset 10 (e.g., available, ordered, in transit, in use).

In some implementations, the inventory management tool 202 uses the data 12 to provide insights 20 about the connected assets 10 in the inventory. The inventory management tool 202 uses one or more algorithms to analyze the data 12 and provide the insights 20. One example insight 20 includes an allocation of the connected asset 10. For example, the user 204 uses the insight 20 to understand where the connected asset 10 is distributed across different locations. Another example insight 20 includes identifying which connected assets 10 require inspection. Another example insight 20 includes identifying which connected assets 10 require repair. Another example insight 20 includes identifying which connected assets 10 require maintenance. The user 204 may use the insights 20 to understand an overview of the inventory and make inventory management decisions.

In some implementations, the inventory management tool 202 uses the data 12 to provide recommended actions 22 to take for the connected asset 10. The inventory management tool 202 uses one or more algorithms to analyze the data 12 and provide the recommended actions 22. One example action 22 is inspecting the connected asset 10. Another example action 22 is repairing the connected asset 10. Another example action 22 is ordering a connected asset 10. Another example action 22 is manufacturing a connected asset 10. Another example action 22 is moving the connected asset 10 to a location. Another example action 22 is installing the connected asset 10. Another example action 22 is using the connected asset 10 for a repair operation.

In some implementations, the inventory management tool 202 uses one or more machine learning models 222 to provide the insights 20 or the actions 22. The machine learning models 222 use one or more algorithms to analyze the data 12 and provide predictions 26 in response to the analysis. The predictions 26 are used in one or more algorithms to generate the insights 20 or actions 22.

One example algorithm is a planning algorithm for asset utilization or optimization. In some implementations, the planning algorithm uses asset traceability, consignment services, consumption analytics, rental services, long-term planning (e.g., more than six months), short-term planning (e.g., less than six months), and global asset utilization optimization information from the data 12 for determining an optimal use of the connected asset 10.

Another example algorithm is a preventative algorithm for asset uptime optimization or asset use optimization. In some implementations, the preventive algorithm uses preservation workflows, predictive maintenance workflows, preventative maintenance workflows information from the data 12 for determining a connected asset 10 uptime and optimizing the length of use of the connected asset 10.

One example of the planning algorithm is to plan the inventory based on demand. The planning algorithm uses the data 12 to identify the usage of the inventory and determines a prediction 26 of what items need to be ordered or manufactured to meet a predicted demand. In some implementations, the predictions 26 are used to generate an insight 20 by the inventory management tool 202 indicating what items are needed to meet the predicted demand. In some implementations, the predictions 26 are used to perform an action 22. For example, the inventory management tool 202 provides a recommendation with the action 22 to purchase or manufacture the items to meet the predicted demand. Another example includes the inventory management tool 202 automatically initiating the manufacturing of the items or purchasing of the items to meet the predicted demand.

Another example of the planning algorithm is to plan the inventory based on a threshold. The planning algorithm uses the data 12 to identify whether a level of the inventory is below a threshold or exceeds a threshold. In some implementations, the planning algorithm provides a prediction 26 of what items are needed in response to the inventory dropping below a threshold. In some implementations, the planning algorithm provides a prediction 26 of what is needed in response to the inventory exceeding a threshold. In some implementations, an insight 20 is generated by the inventory management tool 202 indicating that the inventory dropped below a threshold or exceeded a threshold. In some implementations, the inventory management tool 202 provides a recommendation with an action 22 to move available items from one location to another location in response to the level of inventory dropping below a threshold at the other location. In some implementations, the inventory management tool 202 provides a recommendation with the action 22 to use an item in response to the level of inventory exceeding the threshold. In some implementations, the inventory management tool 202 automatically initiates the manufacturing of the items or purchase of the items in response to the level of inventory dropping below the threshold.

Another example of the planning algorithm is to plan the inventory based on a minimum or maximum level of stock. The planning algorithm uses the data 12 to determine whether a level of inventory has exceeded a maximum level of stock or dropped below a minimum level of stock. In some implementations, the planning algorithm provides a prediction 26 of what items are needed in response to the inventory dropping below a minimum level of stock. In some implementations, an insight 20 is generated by the inventory management tool 202 indicating that the inventory dropped below a minimum level of stock or exceeded a maximum level of stock. In some implementations, the inventory management tool 202 provides a recommendation with the action 22 to purchase or manufacture the items in response to the prediction 26 indicating what items are needed. In some implementations, the inventory management tool 202 provides a recommendation with the action 22 to stop purchasing or manufacturing the items in response to the level of inventory exceeding the maximum level of stock. In some implementations, the inventory management tool 202 automatically initiates the manufacturing of the items or purchase based on the number of items indicated in the prediction 26.

Another example of the planning algorithm is to plan the inventory based on operation consumption. The planning algorithm uses the data 12 to estimate an amount of consumption of materials during an operation and provide a prediction 26 for what materials are needed to complete the operation. For example, the planning algorithm uses the historical data to track consumption patterns at the wellsite and uses the consumption patterns to provide the prediction 26. In some implementations, an insight 20 is generated by the inventory management tool 202 indicating what materials are estimated for completing the operation. In some implementations, the inventory management tool 202 provides a recommendation with an action 22 to purchase or manufacture the materials needed to complete the operation. In some implementations, the inventory management tool 202 provides a recommendation with an action 22 to send the required materials to a location to complete the operation. In some implementations, the inventory management tool 202 automatically initiates the manufacturing of the items or purchase of the materials needed to complete an operation. In some implementations, the inventory management tool 202 automatically initiates sending the materials needed to complete an operation at the location.

Another example of the planning algorithm is to plan the inventory based on a predicted failure. The planning algorithm uses the data 12 to provide a prediction 26 of when a connected asset 10 is going to fail (e.g., stop working properly or stop working). For example, the planning algorithm provides a prediction 26 that a wellhead is going to fail in six months. In some implementations, an insight 20 is generated by the inventory management tool 202 indicating when a connected asset 10 is predicted to fail during operation. In some implementations, the inventory management tool 202 provides a recommendation with an action 22 to start manufacturing an asset at a specific time frame to ensure that the asset is ready for installation before the connected asset 10 fails. In some implementations, the inventory management tool 202 automatically initiates the manufacturing of an asset at a specified time to ensure that the asset is ready prior to the estimated time for failure of the connected asset 10.

Another example of the planning algorithm is to plan the inventory based on an operational forecast. The planning algorithm uses the data 12 to provide a prediction 26 of the operational forecast and determine what materials are necessary for the operational forecast. In some implementations, an insight 20 is generated by the inventory management tool 202 indicating what materials are estimated for the operational forecast. In some implementations, the inventory management tool 202 provides a recommendation with an action 22 to purchase or manufacture the materials needed for the operational forecast. In some implementations, the inventory management tool 202 provides a recommendation with an action 22 to send the required materials to a location for the operation. In some implementations, the inventory management tool 202 automatically initiates sending of the items to the location for the operation.

Another example of the planning algorithm is to plan the inventory based on equipment performance. The planning algorithm uses the data 12 to provide a prediction 26 of a performance of the connected asset 10. In some implementations, an insight 20 is generated by the inventory management tool 202 with a performance prediction for the connected asset 10 indicating a length of use for the connected asset 10 (e.g., the connected asset 10 is expected to be used for three years once installed). In some implementations, an insight 20 is generated by the inventory management tool 202 indicating that the connected asset 10 is underperforming (e.g., performing below an expected threshold level). In some implementations, the inventory management tool 202 provides a recommendation with an action 22 to replace the connected asset 10 prior to the predicted end of use of the connected asset 10. In some implementations, the inventory management tool 202 automatically initiates replacing parts of the connected asset 10 and sending the parts to the location in response to identifying that the connected asset 10 is underperforming.

One example of the preventative algorithm is inspection scheduling for a connected asset 10. The preventative algorithm analyzes the data 12 and uses time-based and movement algorithms to schedule inspections for the connected asset 10. For example, the preventive algorithm schedules an inspect to ensure wear or corrosion has not occurred for the connected asset 10. In some implementations, the inventory management tool 202 provides a recommendation with an action 22 to inspect the connected asset 10 at the scheduled time. In some implementations, the inventory management tool 202 automatically schedules an inspection of the connected asset 10 at the specified time and sends a notification to an individual to perform the inspection of the connected asset 10.

Another example of the preventative algorithm is wear estimation based on cycles and usage. The preventative algorithm analyzes the data 12 and calculates a prediction 26 of the wear of the connected asset 10. For example, the preventative algorithm analyzes the data 12 of the valve cycles and flow or wall conditions to determine the prediction 26 of the wear of the connected asset 10. In some implementations, an insight 20 is generated by the inventory management tool 202 with a prediction of the wear for the connected asset 10. In some implementations, the inventory management tool 202 provides a recommendation with an action 22 to repair the connected asset 10 in response to the prediction of the wear. In some implementations, the inventory management tool 202 provides a recommendation with an action 22 to inspect the connected asset 10 in response to the prediction of the wear. In some implementations, the inventory management tool 202 provides a recommendation with an action 22 for maintenance of the connected asset 10 in response to the prediction of the wear. In some implementations, the inventory management tool 202 automatically initiates the repair of the connected asset 10 in response to the wear estimation and sends a notification to an individual to perform the repair of the connected asset 10 with the items of inventory available for use for the repair.

Another example of the preventative algorithm is a failure prediction using historical data. The preventative algorithm analyzes the data 12 to provide a prediction 26 when the connected asset 10 might fail. For example, the preventive algorithm uses a linear regression of the historical data to provide a prediction 26 when the connected asset 10 or a component of the connected asset 10 might fail (e.g., stop working correctly or stop working). In some implementations, an insight 20 is generated by the inventory management tool 202 with a prediction when the connected asset 10 may fail. In some implementations, the inventory management tool 202 provides a recommendation with an action 22 to repair the connected asset 10 in response to the prediction of failure. In some implementations, the inventory management tool 202 provides a recommendation with an action 22 to inspect the connected asset 10 in response to the prediction of failure. In some implementations, the inventory management tool 202 provides a recommendation with an action 22 for maintenance of the connected asset 10 in response to the prediction of failure. In some implementations, the inventory management tool 202 provides a recommendation with an action 22 to replace the connected asset 10 in response to the prediction of failure. In some implementations, the inventory management tool 202 automatically initiates the replacement of the connected asset 10 in response to the prediction of failure and sends a new asset to the location to replace the connected asset 10.

Another example of the preventative algorithm is a threshold-based environmental monitoring. The preventative algorithm uses the data 12 to trigger alerts when values are out of an expected range. In some implementations, an insight 20 is generated by the inventory management tool 202 indicating that a value of a connected asset 10 is outside of an expected range. In some implementations, the inventory management tool 202 provides a recommendation with an action 22 to repair the connected asset 10 in response to the value being outside of an expected range. In some implementations, the inventory management tool 202 provides a recommendation with an action 22 to inspect the connected asset 10 in response to the value being outside of an expected range. In some implementations, the inventory management tool 202 provides a recommendation with an action 22 for maintenance of the connected asset 10 in response to the value being outside of an expected range. In some implementations, the inventory management tool 202 automatically initiates the inspection of the connected asset 10 in response to value being outside of an expected range and sends a notification to an individual to perform the inspection of the connected asset 10.

Another example of the preventative algorithm is a linear regression and erosion risk. The preventative algorithm analyzes the data 12 using a linear regression and provides a prediction 26 of the erosion risk in response to the analysis. In some implementations, an insight 20 is generated by the inventory management tool 202 indicating a risk of erosion for the connected asset 10. In some implementations, the inventory management tool 202 provides a recommendation with an action 22 to repair the connected asset 10 in response to the risk of erosion. In some implementations, the inventory management tool 202 provides a recommendation with an action 22 to inspect the connected asset 10 in response to the risk of erosion. In some implementations, the inventory management tool 202 provides a recommendation with an action 22 for maintenance of the connected asset 10 in response to the risk of erosion. In some implementations, the inventory management tool 202 provides a recommendation with an action 22 to replace the connected asset 10 in response to the risk of erosion. In some implementations, the inventory management tool 202 automatically initiates the replacement of the connected asset 10 in response to the risk of erosion by ordering a new asset and automatically sending it to the location where the connected asset 10 is in use.

In some implementations, the inventory management tool 202 displays the insights 20 on the user interface 16. The user 204 can view the insights 20 and make inventory decisions in response to the insights 20. In some implementations, the inventory management tool 202 displays the actions 22 on the user interface 16 and the user 204 may perform the actions 22 recommended. In some implementations, the inventory management tool 202 uses the data 12 to automatically perform the actions 22. For example, if the action 22 is ordering more parts, the inventory management tool 202 automatically orders the parts.

In some implementations, the inventory management tool 202 uses the data 12 to provide a response to a request 18 received from the user 204. One example of a request 18 is the user 204 inputs a query about a location of the connected asset 10 and the inventory management tool 202 uses the data 12 to identify the location of the connected asset 10 and display a response to the request 18 with the location of the connected asset 10. Another example of a request 18 is allocating the connected asset 10 to a location. For example, the user 204 inputs a request 18 to move the connected asset 10 to a location and the inventory management tool 202 facilitates the movement of the connected asset 10 to the location. Another example of a request 18 is maintenance planning. For example, the user 204 inputs a request 18 for maintenance for the connected asset 10 and the inventory management tool 202 uses the data 12 to determine if the required materials are available for the requested maintenance.

The inventory management tool 202 automates the inventory management process and allows the users 204 to view a real time status of the inventory. The inventory management tool 202 allows the users 204 to review reports and submit requests 18. The inventory management tool 202 increases the overall efficiency of inventory management for the users 204 by providing the users 204 real time status of inventory, the ability to make requests 18, make changes to stock items in inventory, and produce usage reports of the items in inventory.

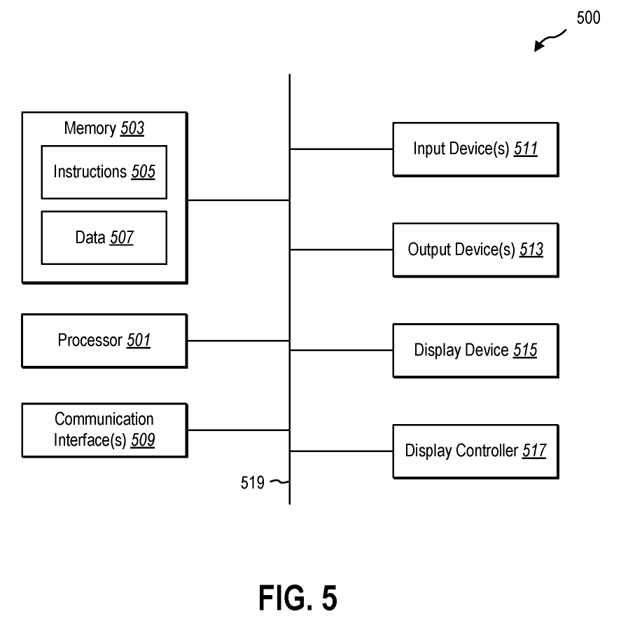

In some implementations, one or more computing devices (e.g., servers and/or devices) are used to perform the processing of the environment 200. The one or more computing devices may include, but are not limited to, server devices, cloud virtual machines, personal computers, a mobile device, such as, a mobile telephone, a smartphone, a PDA, a tablet, or a laptop, and/or a non-mobile device. The features and functionalities discussed herein in connection with the various systems may be implemented on one computing device or across multiple computing devices. For example, the inventory management tool 202 is implemented on a single computing device. Moreover, in some implementations, one or more subcomponents of the feature and functionalities discussed herein may be implemented and processed on different server devices of the same or different cloud computing networks. For example, the inventory management tool 202 is implemented on different server devices. In this way, the environment 200 may be a cloud computing environment, and the inventory management tool 202 may be implemented across one or more devices of the cloud computing environment in order to leverage the processing capabilities, memory capabilities, connectivity, speed, etc., that such cloud computing environments offer in order to facilitate the features and functionalities described herein. Each of the devices of the environment 200 may include features and/or functionalities described below in connection with FIG. 5.

In some implementations, each of the components of the environment 200 is in communication with each other using any suitable communication technologies. In addition, while the components of the environment 200 are shown to be separate, any of the components or subcomponents may be combined into fewer components, such as into a single component, or divided into more components that may serve a particular implementation. In some implementations, the components of the environment 200 include hardware, software, or both. For example, the components of the environment 200 may include one or more instructions stored on a computer-readable storage medium and executable by processors of one or more computing devices. When executed by the one or more processors, the computer-executable instructions of one or more computing devices can perform one or more methods described herein. In some implementations, the components of the environment 200 include hardware, such as a special purpose processing device to perform a certain function or group of functions. In some implementations, the components of the environment 200 include a combination of computer-executable instructions and hardware.

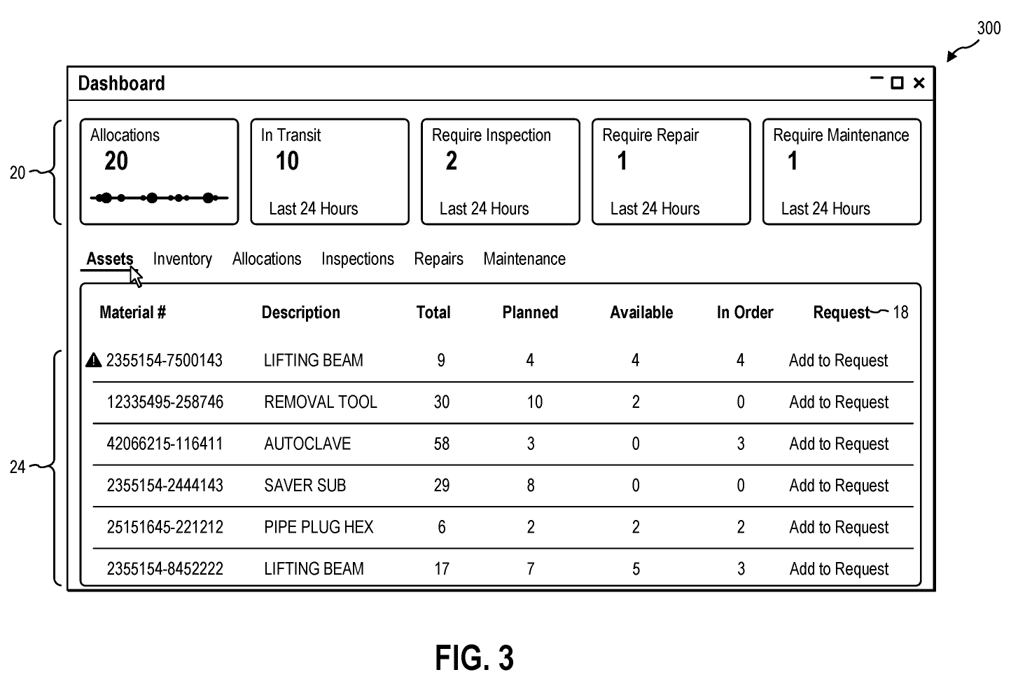

FIG. 3 illustrates an example graphical user interface (GUI) 300 of a real time inventory status. The GUI 300 is displayed on the user interface 16 (FIG. 2) of the display 208 (FIG. 2) by the inventory management tool 202 (FIG. 2). In some implementations, the GUI 300 is displayed in response to a user 204 (FIG. 2) accessing the inventory management tool 202. In some implementations, the GUI 300 is displayed in response to a request 18 (FIG. 2) received by the user 204.

In some implementations, the GUI 300 displays insights 20 generated by the inventory management tool 202. For example, the insights 20 include allocation information for the inventory (e.g., what items are located at which drilling locations worldwide). Another example of the insights 20 includes in transit information (e.g., how many pieces of inventory are currently in transit). Another example of the insights 20 includes required inspections (e.g., which items of inventory currently require inspection). Another example of the insights 20 includes required repair (e.g., which items of inventory currently require repair). Another example of the insights 20 includes required maintenance (e.g., which items of inventory currently require maintenance).

The inventory management tool 202 updates the information displayed on the GUI 300 in real time or near real time with the data 12 (FIG. 2) of the connected assets 10 (FIG. 2) in the inventory system. The insights 20 are generated by the inventory management tool 202 in response to the inventory management tool 202 analyzing the data 12. In some implementations, the inventory management tool 202 analyzes the data 12 using the planning algorithms or preventative algorithms.

In some implementations, the GUI 300 displays an inventory list 24 of available inventory. For example, the inventory list 24 includes the part number or serial number of the available inventory, a description of the available inventory, a total number of items available, a total number of items planned (e.g., planned manufacturing or planned purchases), a total number scheduled for delivery, and a total number ordered. The inventory list 24 is generated by inventory management tool 202 using the data 12 of the connected assets 10 to generate a real time status of the available inventory.

The inventory management tool 202 updates the information presented in the insights 20 and the inventory list 24 as the data 12 changes and items are added or removed from the inventory. The GUI 300 allows a user 204 (FIG. 2) to easily view the real time status of the inventory.

In some implementations, the user 204 uses the insights 20 to make inventory management decisions. One example includes the user 204 using the GUI 300 to provide a request 18 for ordering an item of inventory. Another example includes the user 204 using the GUI 300 to provide a request 18 to move an item of inventory to a different location. Another example includes the user 204 using the GUI 300 to provide a request 18 for an inspection of an item of inventory. Another example includes the user 204 using the GUI 300 to provide a request 18 for a repair of an item of inventory.

The GUI 300 consolidates information from a plurality of data sources (e.g., the data sources 210, 212, 214, 216, 218, 220 (FIG. 2)) into a single location allowing the user 204 to view the real time status of inventory and aid the user in making inventory management decisions.

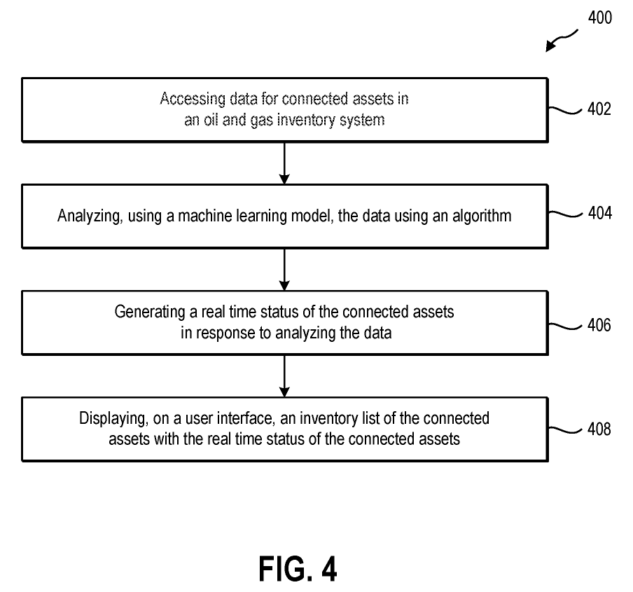

FIG. 4 illustrates an example method 400 for inventory management. The actions of the method 400 are discussed below in reference to FIGS. 1-3.

At 402, the method 400 includes accessing data for connected assets in an oil and gas inventory system. In some implementations, an inventory management tool 202 access data 12 in knowledge graphs 14 for connected assets 10 in an oil and gas inventory system. The connected asset 10 includes information about the item of inventory and additional details that the inventory management tool 202 uses to track the connected asset 10 and provide a current status of the connected asset 10. In some implementations, each connected asset 10 in the inventory system is associated with a knowledge graph 14. In some implementations, the inventory management tool 202 access the data 12 in a network for the connected assets 10 and each connected asset 10 in the inventory system is associated with the network. In some implementations, the inventory management tool 202 accesses the data 12 in a relational database for the connected assets 10 and each connected asset 10 in the inventory system is associated with the relational database.

In some implementations, the data 12 is unstructured data of various types (e.g., text, images, audio, video, tables, or graphs) obtained from a plurality of data sources (e.g., the data sources 210, 212, 214, 216, 218, 220) of the oil and gas industry. In some implementations, the data 12 is structured data of various types (e.g., text, images, audio, video, tables, or graphs) obtained from the plurality of data sources (e.g., the data sources 210, 212, 214, 216, 218, 220) of the oil and gas industry. In some implementations, the data 12 is used to track a status of the connected assets 10 and provide any changes or modifications to the connected assets 10.

At 404, the method 400 includes analyzing, using a machine learning model, the data using an algorithm. In some implementations, the inventory management tool 202 uses a machine learning model 222 to analyze the data 12 using an algorithm. One example of the machine learning model 222 is a linear regression model. Another example of the machine learning model 222 is a generative machine learning model. Another example of the machine learning model 222 is a neural network. In some implementations, the machine learning model 222 uses a planning algorithm in analyzing the data 12. In some implementations, the machine learning model 222 uses a preventative algorithm in analyzing the data 12. In some implementations, the machine learning model 222 uses both the planning algorithm and the preventative algorithm in analyzing the data 12.

In some implementations, the inventory management tool 202 generates a recommendation with an action 22 to take for a connected asset 10 in response to the analyzing the data 12. In some implementations, the inventory management tool 202 displays the recommendation with the action 22 on the user interface 16. The action 22 may be optimized due to availability of the real time information to provide recommendations to the user 204. In some implementations, the inventory management tool 202 automatically performs the action 22 for the connected asset 10 in response to analyzing the data 12. One example of the action 22 is initiating an order for the connected asset 10. Another example of the action 22 is initiating an inspection of the connected asset 10. Another example of the action 22 is initiating a repair of the connected asset 10. Another example of the action 22 is moving the connected asset 10 to a location.

In some implementations, the inventory management tool 202 generates an insight 20 for a connected asset 10 using a prediction 26 generated by the machine learning model 222 in response to analyzing the data 12. In some implementations, the prediction 26 is generated in response to the machine learning model 222 using a planning algorithm or a preventative algorithm to analyze the data 12. The inventory management tool 202 displays the insight 20 for the connected asset 10 on the user interface 16. In some implementations, the inventory management tool 202 receives a request 18 in response to the insight 20 and the inventory management tool 202 uses the real time status of the connected asset 10 to provide a response to the request 18.

At 406, the method 400 includes generating a real time status of the connected assets in response to analyzing the data. In some implementations, the inventory management tool 202 generates a real time status of the connected assets 10 in response to analyzing the data 12. One example of a real time status is determining a current location of the connected assets 10. Another example of a real time status is determining a condition (e.g., new, used, damaged) of the connected assets 10.

At 408, the method 400 includes displaying, on a user interface, an inventory list of the connected assets with the real time status of the connected assets. In some implementations, the inventory management tool 202 displays on a user interface 16 an inventory list 24 of the connected assets with the real time status of each connected asset 10 in the inventory list 24.

In some implementations, the inventory management tool 202 receives a request 18 from a user 204 relating to the inventory. For example, the request 18 includes a query about the inventory. Another example includes the request 18 schedules an inspection for the inventory. The inventory management tool 202 uses the real time status of the connected assets 10 to provide a response to the request 18.

In some implementations, the inventory management tool 202 receives a request 18 from the user 204 using the user interface 16 to provide a request 18 relating to the inventory. For example, the user 204 selects an icon on the user interface 16 to provide the request 18. Another example includes the user 204 inputs text using the user interface 16 to provide the request 18. The inventory management tool 202 uses the real time status of the connected assets 10 in the inventory list 24 to determine if a connected asset 10 is available for the request 18. The inventory management tool 202 assigns the connected asset 10 to the request 18 in response to determining the connected asset 10 is available for the request 18. In some implementations, the inventory management tool 202 automatically orders an item of inventory for the request in response to determining that the connected assets are unavailable for the request 18.

The method 400 automates the inventory management process and allows the users 204 to view a real time status of the connected assets 10.

Turning now to FIG. 5, this figure illustrates certain components that may be included within a computer system 500. One or more computer systems 500 may be used to implement the various devices, components, and systems described herein.

The computer system 500 includes a processor 501. The processor 501 may be a general-purpose single- or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 501 may be referred to as a central processing unit (CPU). Although just a single processor 501 is shown in the computer system 500 of FIG. 5, in an alternative configuration, a combination of processors (e.g., an ARM and DSP) could be used.

The computer system 500 also includes memory 503 in electronic communication with the processor 501. The memory 503 may include computer-readable storage media and can be any available media that can be accessed by a general purpose or special purpose computer system. Computer-readable media that store computer-executable instructions are non-transitory computer-readable media (device). Computer-readable media that carry computer-executable instructions are transmission media. Thus, by way of example and not limitations, implementation of the present disclosure can comprise at least two distinctly different kinds of computer-readable media: non-transitory computer-readable media (devices) and transmission media.

Both non-transitory computer-readable media (devices) and transmission media may be used temporarily to store or carry software instructions in the form of computer readable program code that allows performance of implementations of the present disclosure. Non-transitory computer-readable media may further be used to persistently or permanently store such software instructions. Examples of non-transitory computer-readable storage media include physical memory (e.g., RAM, ROM, EPROM, EEPROM, etc.), optical disk storage (e.g., CD, DVD, HDDVD, Blu-ray, etc.), storage devices (e.g., magnetic disk storage, tape storage, diskette, etc.), flash or other solid-state storage or memory, or any other non-transmission medium which can be used to store program code in the form of computer-executable instructions or data structures and which can be accessed by a general purpose or special purpose computer, whether such program code is stored or in software, hardware, firmware, or combinations thereof.

Instructions 505 and data 507 may be stored in the memory 503. The instructions 505 may be executable by the processor 501 to implement some or all of the functionality disclosed herein. Executing the instructions 505 may involve the use of the data 507 that is stored in the memory 503. Any of the various examples of modules and components described herein may be implemented, partially or wholly, as instructions 505 stored in memory 503 and executed by the processor 501. Any of the various examples of data described herein may be among the data 507 that is stored in memory 503 and used during execution of the instructions 505 by the processor 501.

A computer system 500 may also include one or more communication interfaces 509 for communicating with other electronic devices. The communication interface(s) 509 may be based on wired communication technology, wireless communication technology, or both. Some examples of communication interfaces 509 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

The communication interfaces 509 may connect the computer system 500 to a network. A “network” or “communications network” may generally be defined as one or more data links that enable the transport of electronic data between computer systems and/or modules, engines, or other electronic devices, or combinations thereof. When information is transferred or provided over a communication network or another communications connection (either hardwired, wireless, or a combination of hardwired or wireless) to a computing device, the computing device properly views the connection as a transmission medium. Transmission media can include a communication network and/or data links, carrier waves, wireless signals, and the like, which can be used to carry desired program or template code means or instructions in the form of computer-executable instruction or data structures and which can be accessed by a general purpose or special purpose computer.

A computer system 500 may also include one or more input devices 511 and one or more output devices 513. Some examples of input devices 511 include a keyboard, mouse, microphone, remote control device, button, joystick, trackball, touchpad, and lightpen. Some examples of output devices 513 include a speaker and a printer. One specific type of output device that is typically included in a computer system 500 is a display device 515. Display devices 515 used with implementations disclosed herein may utilize any suitable image projection technology, such as liquid crystal display (LCD), light-emitting diode (LED), gas plasma, electroluminescence, or the like. A display controller 517 may also be provided, for converting data 507 stored in the memory 503 into one or more of text, graphics, or moving images (as appropriate) shown on the display device 515.

The various components of the computer system 500 may be coupled together by one or more buses, which may include one or more of a power bus, a control signal bus, a status signal bus, a data bus, other similar components, or combinations thereof. For the sake of clarity, the various buses are illustrated in FIG. 5 as a bus system 519.

As illustrated in the foregoing discussion, the present disclosure utilizes a variety of terms to describe features and advantages of the model evaluation system. Additional detail is now provided regarding the meaning of such terms. For example, as used herein, a “machine learning model” refers to a computer algorithm or model (e.g., a classification model, a clustering model, a regression model, a language model, an object detection model, a probabilistic graphical model) that can be tuned (e.g., trained) based on training input to approximate unknown functions. For example, a machine learning model may refer to a neural network (e.g., a convolutional neural network (CNN), deep neural network (DNN), recurrent neural network (RNN)), or other machine learning algorithm or architecture that learns and approximates complex functions and generates outputs based on a plurality of inputs provided to the machine learning model. As used herein, a “machine learning system” may refer to one or multiple machine learning models that cooperatively generate one or more outputs based on corresponding inputs. For example, a machine learning system may refer to any system architecture having multiple discrete machine learning components that consider different kinds of information or inputs.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various implementations.

Further, upon reaching various computer system components, program code in the form of computer-executable instructions or data structures can be transferred automatically or manually from transmission media to non-transitory computer-readable storage media (or vice versa). For example, computer executable instructions or data structures received over a network or data link can be buffered in memory (e.g., RAM) within a network interface module (NIC), and then eventually transferred to computer system RAM and/or to less volatile non-transitory computer-readable storage media at a computer system. Thus, it should be understood that non-transitory computer-readable storage media can be included in computer system components that also (or even primarily) utilize transmission media.

### INDUSTRIAL APPLICABILITY

The following description from ¶¶ (0012)-(0091) includes various implementations that, where feasible, may be combined in any permutation. For example, the implementation of ¶¶ (0012-(0091) may be combined with any or all implementations of the following paragraphs. Implementations that describe acts of a method may be combined with implementations that describe, for example, systems and/or devices. Any permutation of the following paragraphs is considered to be hereby disclosed for the purposes of providing “unambiguously derivable support” for any claim amendment based on the following paragraphs. Furthermore, the following paragraphs provide support such that any combination of the following paragraphs would not create an “intermediate generalization.”

In some implementations, a method includes accessing data for connected assets in an oil and gas inventory system. The method includes analyzing, using a machine learning model, the data using an algorithm. The method includes generating a real time status of the connected assets in response to analyzing the data. The method includes displaying, on a user interface, an inventory list of the connected assets with the real time status of the connected assets.

In some implementations, the method includes the data is in a knowledge graph, a network, or a relational database and each connected asset is associated with the knowledge graph, the network, or the relational database.

In some implementations, the method includes the data is structured data or unstructured data in various types obtained from a plurality of data sources of the oil and gas industry.

In some implementations, the method includes the data is used to track a status of the connected assets and provide any changes or modifications to the connected assets.

In some implementations, the method includes generating a recommendation with an action to take for a connected asset in response to analyzing the data, wherein the machine learning model uses a planning algorithm or a preventative algorithm in analyzing the data; and displaying the recommendation with the action to take for the connected asset.

In some implementations, the method includes automatically performing an action for a connected asset in response to analyzing the data.

In some implementations, the method includes the action is initiating an order for the connected asset, initiating an inspection of the connected asset, initiating a repair of the connected asset, or moving the connected asset to a location.

In some implementations, the method includes generating an insight for a connected asset using a prediction generated by the machine learning model in response to analyzing the data; displaying the insight for the connected asset; receiving a request in response to the insight; and using a real time status of the connected asset to provide a response to the request.

In some implementations, the method includes the prediction is generated in response to the machine learning model using a planning algorithm or a preventative algorithm in analyzing the data.

In some implementations, the method includes receiving a request from a user relating to the inventory; and using the real time status of the connected assets to provide a response to the request.

In some implementations, the method includes receiving, using the user interface, a request from a user relating to the inventory list; determining, using the real time status of the connected assets, if a connected asset is available for the request; assigning the connected asset to the request in response to determining the connected asset is available for the request; and automatically ordering an item of inventory for the request in response to determining the connected assets are unavailable for the request.

In some implementations, the system includes a memory to store data and instructions; and a processor operable to communicate with the memory, wherein the processor is operable to: access data for connected assets in an oil and gas inventory system; analyze, using a machine learning model, the data using an algorithm; generate a real time status of the connected assets in response to analyzing the data; and display, on a user interface, an inventory list of the connected assets with the real time status of the connected assets.

In some implementations, a computer-readable storage medium including instructions that, when executed by a processor, cause the processor to: access data for connected assets in an oil and gas inventory system; analyze, using a machine learning model, the data using an algorithm; generate a real time status of the connected assets in response to analyzing the data; and display, on a user interface, an inventory list of the connected assets with the real time status of the connected assets.

One or more specific implementations of the present disclosure are described herein. These described implementations are examples of the presently disclosed techniques. Additionally, in an effort to provide a concise description of these implementations, not all features of an actual implementation may be described in the specification. It should be appreciated that in the development of any such actual implementation, as in any engineering or design project, numerous implementation-specific decisions will be made to achieve the developers’ specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Additionally, it should be understood that references to “one implementation” or “an implementation” of the present disclosure are not intended to be interpreted as excluding the existence of additional implementations that also incorporate the recited features. For example, any element described in relation to an implementation herein may be combinable with any element of any other implementation described herein. Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to implementations disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. There is no intention to invoke means-plus-function or other functional claiming for any claim except for those in which the words ‘means for’ appear together with an associated function. Each addition, deletion, and modification to the implementations that falls within the meaning and scope of the claims is to be embraced by the claims.

The terms “approximately,” “about,” and “substantially” as used herein represent an amount close to the stated amount that is within standard manufacturing or process tolerances, or which still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements. Additionally, as used herein, the term “and/or” includes any and all combinations of one or more of the associated listed items.

The present disclosure may be embodied in other specific forms without departing from its spirit or characteristics. The described implementations are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method, comprising:
accessing data for connected assets in an oil and gas inventory system;
analyzing, using a machine learning model, the data using an algorithm;
generating a real time status of the connected assets in response to analyzing the data; and
displaying, on a user interface, an inventory list of the connected assets with the real time status of the connected assets.

2. The method of claim 1, wherein the data is in a knowledge graph, a network, or a relational database and each connected asset is associated with the knowledge graph, the network, or the relational database.

3. The method of claim 1, wherein the data is structured data or unstructured data of various types obtained from a plurality of data sources of the oil and gas industry.

4. The method of claim 1, wherein the data is used to track a status of the connected assets and provide any changes or modifications to the connected assets.

5. The method of claim 1, further comprising:
generating a recommendation with an action to take for a connected asset in response to analyzing the data, wherein the machine learning model uses a planning algorithm or a preventative algorithm in analyzing the data; and
displaying the recommendation with the action to take for the connected asset.

6. The method of claim 1, further comprising:
automatically performing an action for a connected asset in response to analyzing the data.

7. The method of claim 6, wherein the action is initiating an order for the connected asset, initiating an inspection of the connected asset, initiating a repair of the connected asset, moving the connected asset to a location.

8. The method of claim 1, further comprising:
generating an insight for a connected asset using a prediction generated by the machine learning model in response to analyzing the data, wherein the prediction is generated in response to the machine learning model using a planning algorithm or a preventative algorithm in analyzing the data;
displaying the insight for the connected asset;
receiving a request in response to the insight; and
using a real time status of the connected asset to provide a response to the request.

9. The method of claim 1, further comprising:
receiving a request from a user relating to the inventory list; and
using the real time status of the connected assets to provide a response to the request.

10. The method of claim 1, further comprising:
receiving, using the user interface, a request from a user relating to the inventory;
determining, using the real time status of the connected assets, if a connected asset is available for the request;
assigning the connected asset to the request in response to determining the connected asset is available for the request; and
automatically ordering an item of inventory for the request in response to determining the connected assets are unavailable for the request.

11. A system, comprising:
a memory to store data and instructions; and
a processor operable to communicate with the memory, wherein the processor is operable to:
access data for connected assets in an oil and gas inventory system;
analyze, using a machine learning model, the data using an algorithm;
generate a real time status of the connected assets in response to analyzing the data; and
display, on a user interface, an inventory list of the connected assets with the real time status of the connected assets.

12. The system of claim 11, wherein the data is in a knowledge graph, a network, or a relational database and each connected asset is associated with the knowledge graph, the network, or the relational database.

13. The system of claim 11, wherein the data is structured data or unstructured data in various types obtained from a plurality of data sources of the oil and gas industry.

14. The system of claim 11, wherein the data is used to track a status of the connected assets and provide any changes or modifications to the connected assets.

15. The system of claim 11, wherein the processor is further operable to:
generate a recommendation with an action to take for a connected asset in response to analyzing the data, wherein the machine learning model uses a planning algorithm or a preventative algorithm in analyzing the data; and
display the recommendation with the action to take for the connected asset.

16. The system of claim 11, wherein the processor is further operable to:
automatically perform an action for a connected asset in response to analyzing the data.

17. The system of claim 16, wherein the action is initiating an order for the connected asset, initiating an inspection of the connected asset, initiating a repair of the connected asset, or moving the connected asset to a location.

18. The system of claim 11, wherein the processor is further operable to:
generate an insight for a connected asset using a prediction generated by the machine learning model in response to analyzing the data, wherein the prediction is generated in response to the machine learning model using a planning algorithm or a preventative algorithm in analyzing the data in knowledge graphs;
display the insight for the connected asset;
receive a request in response to the insight; and
use a real time status of the connected asset to provide a response to the request.

19. The system of claim 11, wherein the processor is further operable to:
receive a request from a user relating to the inventory list; and
use the real time status of the connected assets to provide a response to the request.

20. The system of claim 11, wherein the processor is further operable to:
receive, using the user interface, a request from a user relating to the inventory;
determine, using the real time status of the connected assets, if a connected asset is available for the request;
assign the connected asset to the request in response to determining the connected asset is available for the request; and
automatically order an item of inventory for the request in response to determining the connected assets are unavailable for the request.
